(19) United States
(12) Patent Application Publication
(10) Pub. No.: US 2025/0369139 A1
(43) Pub. Date: Dec. 4, 2025

(54) OXYGEN GENERATION SYSTEMS FOR LOW GRAVITY APPLICATIONS

(71) Applicant: Hamilton Sundstrand Corporation, Charlotte, NC (US)

(72) Inventors: Christopher H. Miller, West Springfield, MA (US); Andrew D. Campbell, Hartford, CT (US); Timothy Myles, Woodstock, CT (US); Luke Blaskewicz, Monroe, CT (US); Beakal Teshome Woldemariam, South Windsor, CT (US)

(21) Appl. No.: 18/733,078

(22) Filed: Jun. 4, 2024

(51) Int. Cl. C25B 15/029; C25B 1/04; C25B 9/73; C25B 15/08

(52) U.S. Cl. CPC C25B 15/029; C25B 1/04; C25B 9/73; C25B 15/087

(57) ABSTRACT

Oxygen generation systems for use in low-gravity environments include a cell stack having an anode and a cathode. An anode-side phase separator and a cathode-side phase separator are each fluidly coupled to outlets of the cell stack. The anode-side phase separator separates a mixture into liquid water and gaseous oxygen and the cathode-side phase separates a mixture int liquid water and gaseous hydrogen. A ducting system is configured to house the cell stack and the cathode-side phase separator, a hydrogen sensor is arranged at an outlet of the ducting system, and a controller is configured to stop oxygen generation at the cell stack when a concentration of hydrogen is detected at or above a threshold level at the hydrogen sensor at the outlet of the ducting system.

### BACKGROUND

The subject matter disclosed herein generally relates to oxygen generation and, more particularly, to oxygen generation in low-gravity applications (e.g., space, non-earth celestial bodies, etc.).

Human exploration into space poses many challenges, particularly with respect to resources for ensuring human survivability and safety. For example, generation of breathable air, and particularly the generation of oxygen, is a key to ensure human safety and longevity when in space or other low-gravity environments. Further, oxygen generation may be important for generation of fuel or for other purposes, and thus these systems may be mission critical.

In performing water electrolysis in space or in other low gravity environments (inclusive of zero gravity environments), it is desirable to separate process water from product gases (i.e., H₂ and O₂). Further, it is important not to waste or discharge any of the process water or product gases. Recapture and reuse of materials can reduce the amount of material to be launched and carried onboard a craft of the like.

In terrestrial applications, product gases are separated from the process water in gravity separators. The hydrogen-side water is then re-injected into the circulating oxygen side water loop. This process relies, in part, on the force of gravity to aid the separation of the components of the flow (e.g., water, hydrogen, oxygen).

In contrast, in accordance with some current oxygen-separation systems, phase separation is performed using two rotary separators, which replace the gravity separators of the terrestrial applications. The rotary separators are used due to the lack of gravity, and thus an active separation mechanism is implemented that relies on the two rotary separators. The rotary separators are complicated pieces of machinery that contain moving parts (e.g., rotary), sensors, and requires a control scheme that works in concert with the rest of the system. Furthermore, a purge system using inert gas may also be incorporated in the system for hydrogen and oxygen safety. That is, the purge system may flush all or a part of the system with an inert gas to avoid build-up of hydrogen and/or oxygen. The inclusion of all of these components can result in relatively expensive systems with complex configurations which can increase maintenance costs and complexity of performing maintenance thereon by users of the system (e.g., in space or, at least, remote from Earth).

Other types of space-based systems include cathode-feed electrolyzers. In these systems, oxygen generation is achieved in a low-gravity environment using a custom cathode-feed electrolyzer. These systems (and the rotary systems discussed above), are used in closed-loop environments (e.g., spacecraft, space station (traveling, orbit, on surface), etc.). The phase separators are used recover any products of this reaction, specifically the water and hydrogen. In the cathode-feed configurations, a cathode-feed electrolyzer only requires a separator on the cathode outlet. Additionally, due to safety concerns related to free hydrogen, the systems typically include containers, domes, or the like to contain and vent any hydrogen leakage that might occur. That is, the container may be a vessel that can collection and contain any free hydrogen within the container, and then a venting or flushing operation, such as by introduction of an inert gas, may be used to clear the container and/or dilute the hydrogen to safe concentrations. However, such systems may be expensive or complex and may pose various safety concerns that must be addressed, such as by including the noted dome/container to contain free hydrogen and potential combustion.

In view of the above and other considerations, improvements in phase separation systems onboard spacecraft and/or in low-gravity environments may provide advantages to human space exploration and increase presence in space and on other celestial bodies.

### SUMMARY

According to some embodiments, oxygen generation systems for use in low-gravity environments are provided. The oxygen generation systems include a cell stack having an anode and a cathode, wherein the anode is configured to receive liquid water as an input at a stack inlet and output a mixture of liquid water and gaseous oxygen and wherein the cathode is configured to output a mixture of liquid water and gaseous hydrogen. An anode-side phase separator is fluidly coupled to an outlet of the anode, wherein the anode-side phase separator is configured to separate the mixture of liquid water and gaseous oxygen into liquid water and gaseous oxygen, wherein the gaseous oxygen is directed to an oxygen outlet. A cathode-side phase separator is fluidly coupled to an outlet of the cathode, wherein the cathode-side phase separator is configured to separate the mixture liquid water and gaseous hydrogen into liquid water and gaseous hydrogen, wherein the gaseous hydrogen is directed to a hydrogen outlet. A ducting system is configured to house the cell stack and the cathode-side phase separator. A hydrogen sensor is arranged at an outlet of the ducting system. A controller is configured to stop oxygen generation at the cell stack when a concentration of hydrogen is detected at or above a threshold level at the hydrogen sensor at the outlet of the ducting system.

In addition to one or more of the features described herein, or as an alternative, further embodiments of the oxygen generation systems may include a fixed-volume path between the cathode and the cathode-side phase separator, wherein the fixed-volume path is arranged within the ducting system.

In addition to one or more of the features described herein, or as an alternative, further embodiments of the oxygen generation systems may include a fan arranged to generate a flow of air through the ducting system.

In addition to one or more of the features described herein, or as an alternative, further embodiments of the oxygen generation systems may include a water control assembly arranged to receive and combine the liquid water from each of the anode-side phase separator and the cathode-side phase separator, and direct the combined liquid water back to the stack inlet.

In addition to one or more of the features described herein, or as an alternative, further embodiments of the oxygen generation systems may include that the water control assembly comprises a pump operable to circulate water through the system.

In addition to one or more of the features described herein, or as an alternative, further embodiments of the oxygen generation systems may include that the water control assembly comprises an expansion device configured to accommodate expansion of fluid volume within the system.

In addition to one or more of the features described herein, or as an alternative, further embodiments of the oxygen generation systems may include a recombiner arranged to receive hydrogen output from the hydrogen phase separator.

In addition to one or more of the features described herein, or as an alternative, further embodiments of the oxygen generation systems may include an anode-side flow controller arranged between the anode-side phase separator and the water control assembly, the anode-side flow controller configured to cause a pressure differential such that an upstream side of the anode-side flow controller is at a greater pressure than a downstream side of the anode-side flow controller; a cathode-side flow controller arranged between the cathode-side phase separator and the water control assembly, the cathode-side flow controller configured to cause a pressure differential such that an upstream side of the cathode-side flow controller is at a greater pressure than a downstream side of the cathode-side flow controller; and an input flow controller arranged between the water control assembly and the stack inlet, the input flow controller configured to cause a pressure differential such that an upstream side of the input flow controller is greater than a downstream side of the input flow controller.

In addition to one or more of the features described herein, or as an alternative, further embodiments of the oxygen generation systems may include that each of the anode-side phase separator and the cathode-side phase separator are membrane phase separators.

In addition to one or more of the features described herein, or as an alternative, further embodiments of the oxygen generation systems may include a water replenishment system configured to supply water into the mixture of liquid water and gaseous oxygen that is output from the anode.

In addition to one or more of the features described herein, or as an alternative, further embodiments of the oxygen generation systems may include that the water replenishment system comprises a forward pressure regulator arranged between a water source and a resupply junction, wherein the resupply junction is located between the anode and the anode-side phase separator.

In addition to one or more of the features described herein, or as an alternative, further embodiments of the oxygen generation systems may include that the water control assembly comprises a pump configured to control a pressure of the water within the system.

In addition to one or more of the features described herein, or as an alternative, further embodiments of the oxygen generation systems may include a set of pressure sensors arranged within the system and configured to monitor a fluid pressure at respective locations of the pressure sensors, wherein the pressure sensors are arranged in communication with the controller.

In addition to one or more of the features described herein, or as an alternative, further embodiments of the oxygen generation systems may include that a sweep flow of air is supplied into oxygen portions of the anode-side phase separator to flush residual free hydrogen from the anode-side phase separator.

In addition to one or more of the features described herein, or as an alternative, further embodiments of the oxygen generation systems may include that the oxygen outlet is fluidly connected to a space to be occupied by humans.

In addition to one or more of the features described herein, or as an alternative, further embodiments of the oxygen generation systems may include that the oxygen outlet is fluidly connected to an oxygen storage system.

According to some embodiments, methods of generating oxygen in low-gravity environments are provided. The method includes supplying water to a stack inlet of a cell stack comprising an anode and a cathode and performing electrolysis on the water, wherein the stack inlet is fluidly coupled to the anode; outputting a flow of liquid water and gaseous oxygen from the anode; separating the gaseous oxygen from the liquid water in an anode-side phase separator; directing the gaseous oxygen to an oxygen outlet; outputting a flow of liquid water and gaseous hydrogen from the cathode; separating the gaseous hydrogen from the liquid water in a cathode-side phase separator; directing the gaseous hydrogen to a hydrogen outlet; directing the liquid water output from the anode-side phase separator and the cathode-side phase separator back to the stack inlet; monitoring a concentration of hydrogen within a ducting system, wherein the cell stack and the cathode-side phase separator are housed within the ducting system; and in response to a detection of a hydrogen concentration at or above a threshold concentration within the ducting system, stopping the electrolysis in the cell stack.

In addition to one or more of the features described herein, or as an alternative, further embodiments of the methods may include directing the liquid water output from the anode-side phase separator and the cathode-side phase separator to a water control assembly; recombining the water from the anode-side phase separator and the cathode-side phase separator in the water control assembly; and directing the recombined water to the stack inlet.

In addition to one or more of the features described herein, or as an alternative, further embodiments of the methods may include adding water to the system along a fluid path between an outlet of the anode and an inlet of the anode-side phase separator, wherein the water is added from a water replenishment system.

In addition to one or more of the features described herein, or as an alternative, further embodiments of the methods may include that the water replenishment system comprises a water source and a forward pressure regulator, the method further including adding water to the system from the water source to maintain a predetermined water volume or water pressure within the system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic diagram of an oxygen generation system in accordance with an embodiment of the present disclosure;

FIG. 2 is a schematic diagram of another oxygen generation system in accordance with an embodiment of the present disclosure;

FIG. 3 is a schematic diagram of another oxygen generation system in accordance with an embodiment of the present disclosure; and

FIG. 4 is a schematic diagram of another oxygen generation system in accordance with an embodiment of the present disclosure.

### DETAILED DESCRIPTION

As discussed above, the current methods for phase separation in low-gravity environments, particularly for oxygen generation, may include the use of rotary separators. The rotary separator systems are expensive and complicated pieces of machinery that contain moving parts, sensors, and require control schemes that work in concert with the rest of the system. In such systems, a purge mechanism using inert gas must also be employed to ensure that concentrations of hydrogen do not exceed safe concentrations. Each of these components may be subject to failure for a variety of reasons when operated in low-gravity environments. As used herein, the term “low-gravity environment” refers to and is inclusive of environments that are subject to less gravitation force than on Earth (e.g., less than 1 g). Such environments include orbits, travel between celestial bodies, and operations on non-Earth celestial bodies. Further, this term is inclusive of zero-gravity environments.

In addition to being subject to low gravity, and thus requiring components that remove reliance thereon, components of these systems may also be exposed to radiation and cosmic particles which can interfere with or damage components, particularly control elements, such as controllers and circuit boards. Accordingly, reducing the “on” time of any electronics and/or eliminating such components in favor of a more passive or at least less electronic solution can provide for improved reliability, performance, and operational life of these oxygen generation systems.

In view of the above, and other considerations, membrane contactors are incorporated into oxygen generation systems in accordance with embodiments of the present disclosure. The membrane contactors can provide a relatively cheap and passive method of phase separation as compared to rotary separators or the like. Due to the lack of gravity in low-gravity environments, systems in accordance with the present disclosure may be pre-filled or pre-charged with liquid water to ensure proper separation of product gases from the liquid water. Such pre-filling ensures that the separation of gas from the liquid water will reach appropriate concentrations and efficiency to be a viable solution in low-gravity environments. Accordingly, some embodiments of the present disclosure are directed to ensuring filling or charging of the system with liquid water.

Further, in accordance with some embodiments of the present disclosure, a conventional inert gas purge system may be replaced with a water back-fill system to serve the same safety function. In some such systems, make-up water or supplemental water supply may be a passive continuous feed, and thus may eliminate the need for a sensor-and-actuator-based control scheme. In accordance with some embodiments, recirculation of water from a cathode loop that is directed into an anode loop may be moved from an outlet of a cell stack to inlet of the cell stack on the anode side. Further, in some such embodiments, the system may include multiple flow controllers (e.g., settable orifices, valves, or the like) which may be configured to maintain necessary pressures required for effective phase separation and safety. In accordance with some embodiments, due to the use of liquid water and ensuring a water back-fill, some embodiments of the present disclosure may include a volume compensation device or accumulator that is provided along a flow path to accommodate volume changes while maintaining necessary pressures and ensuring liquid water pre-filling.

Additionally, embodiments of the present disclosure are directed to hydrogen safety approaches to address hydrogen capture and/or management due to potential leakages and/or hydrogen that stays within the system after shutdown, power loss, or the like. In conventional low-gravity systems, one or more containers (e.g., domes or other containment vessels) are arranged and configured to contain any free hydrogen, and the containers may be vented to ensure that any hydrogen that is present in the system when it shouldn't be present (e.g., off state, during shutdown or startup, or the like) is removed. The venting of such container-based systems (e.g., dome-systems) may be performed by pumping an inert gas into the system to flush the hydrogen out and/or dilute the free hydrogen to safe concentrations and/or evacuating to vacuum. In contrast to such a containment system, embodiments of the present disclosure employ a ducting system or ducting assembly for partial containment, detection, dilution, and venting. For example, in some embodiments, a venting flow will be directed or ducted around the components of the system that contain hydrogen, such that the venting flow will pick up any free hydrogen. The venting flow may be an inert gas or may be air from an ambient location (e.g., occupied space, crew quarters, cabin, etc.). The ducting system may be monitored by one or more hydrogen sensors to monitor concentrations of hydrogen in the ducting system. If hydrogen concentrations reach a predetermined threshold (e.g., due to escaping hydrogen during oxygen production), the oxygen production may be shut down and/or the venting flow may be increased to assure dilution and removal of the excess hydrogen. Once hydrogen concentrations are reduced below the threshold, or below a restart threshold (which may be before the hydrogen threshold), the system may be restarted.

These and other features and aspects of oxygen generation systems for low-gravity applications will become apparent in view of the below described example embodiments. It will be appreciated that although a limited number of specific examples are provided herein, features of the various embodiments may be combined or rearranged without departing from the scope of the present disclosure. That is, the illustrative embodiments shown and described herein are merely for explanatory purposes and are not intended to be limited to only the specific configuration and arrangement of the individual embodiments.

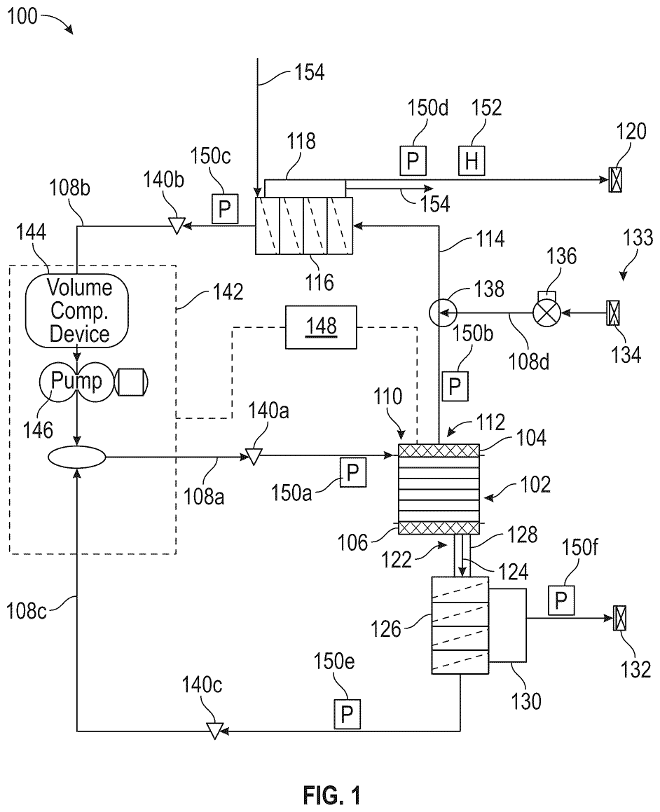

Referring now to FIG. 1, a schematic diagram of an oxygen generation system 100 in accordance with an embodiment of the present disclosure is shown. The oxygen generation system 100 may be used in low-gravity environments, such as onboard spacecraft, space stations, vehicles or structures located in low-gravity environments, and the like. As noted above, the term “low-gravity” refers to gravity being less than 1 g (i.e., Earth-gravity), and is inclusive of low-and micro-gravity environments, in addition to zero gravity environments. The oxygen generation system 100 is configured as an anode-feed system, having a cell stack 102 with an anode 104 and a cathode 106. Input water 108a is fed into the anode 104 at a stack inlet 110 of the cell stack 102 and electrolyzed into two output flows. At an anode outlet 112 of the cell stack 102, the oxygen generation system 100 outputs a flow of oxygen and water 114 which is directed to an anode-side phase separator 116. The flow of oxygen and water 114 is separated into component parts by the anode-side phase separator 116, resulting in an anode-side flow of water 108b that is directed back to the cell stack 102, as described herein. The oxygen of the flow of oxygen and water 114 is separated by the anode-side phase separator 116 and output as gaseous oxygen 118, which is directed to an oxygen outlet 120. The oxygen outlet 120 may be fluidly connected to a cabin or other occupied space for breathing and/or may be fluidly connected to a storage container or the like for storing gaseous oxygen (e.g., for medical uses, fuel, or for other purposes as will be appreciated by those of skill in the art).

At the cell stack 102, the second output flow is directed through a cathode outlet 122 of the cell stack 102. A flow of hydrogen and water 124 is directed from the cathode outlet 122 to a cathode-side phase separator 126. The flow of hydrogen and water 124 is separated into component parts by the cathode-side phase separator 126, resulting in a cathode-side flow of water 108c that is directed back to the cell stack 102, as described herein. Due to the nature of free hydrogen, the flow of hydrogen and water 124 may be directed through a control volume path 128, thus limiting the opportunity for hydrogen to leak or escape from the system 100. The control volume path 128 is a fixed length and diameter (i.e., fixed volume) path through which a flow of hydrogen and water 124 that is separated or evolved in the cell stack 102 may be passed. The control volume path 128 is provided for safety functionality to limit the length of the path that free hydrogen may flow, thereby reducing the amount and risk of leaks of free hydrogen, which may potentially pose a danger if a critical concentration of hydrogen builds up. The hydrogen of the flow of hydrogen and water 124 is separated by the cathode-side phase separator 126 and output as gaseous hydrogen 130, which is directed to a hydrogen outlet 132. The hydrogen outlet 132 may be fluidly connected to a vent to evacuate the hydrogen and/or may be fluidly connected to a storage container or the like for storing gaseous hydrogen (e.g., for fuel or for other purposes as will be appreciated by those of skill in the art).

Accordingly, the oxygen generation system 100 is configured to generate gaseous oxygen 118 and gaseous hydrogen 130 from the input water 108a. The system 100 may be substantially closed loop, such that water from both the anode outlet 112 (water 108b) and water from the cathode outlet 122 (water 108c) are rejoined or recombined and then reintroduced at or upstream from the stack inlet 110 of the cell stack 102 to form the input water 108a. Because the purpose of the cell stack 102 is to generate the gaseous oxygen 118 from the input water 108a, a portion of the water (collectively referred to as water 108) will be consumed. As such, a water replenishment system 133 is provided. The water replenishment system 133 is configured to direct a resupply water 108d into the oxygen generation system 100 to ensure that sufficient water 108 is present within the oxygen generation system 100. The water replenishment system 133 includes a water source 134 that is fluidly coupled to part of the anode-side of the oxygen generation system 100. For example, as shown in this configuration, the resupply water 108d may be introduced into the flow of oxygen and water 114 at a location upstream from the anode-side phase separator 116.

The water replenishment system 133 includes a forward pressure regulator 136 arranged between the water source 134 and a resupply junction 138. The forward pressure regulator 136 is provided to ensure that the quantity (e.g., volume) of water 108 within the oxygen generation system 100 is maintained at levels, volumes, or pressures to keep water pressures sufficient for operation of the cell stack 102 and the phase separators 116, 126. That is, the water replenishment system 133, and the forward pressure regulator 136 are configured to ensure that a water volume and/or water pressure within the system 100 is maintain at a predetermined volume and/or pressure. The predetermined volume and/or pressure may be based, for example, on the operational parameters of the cell stack 102 and/or the phase separators 116, 126. For example, the operational parameters may be a minimum water volume and/or water pressure that is required to allow safe electrolysis within the cell stack 102 and/or phase separation within the phase separators 116, 126. The forward pressure regulator 136 is arranged as a direction flow controller to ensure that the resupply water 108d flows from the water source 134 into the water flow path of the oxygen generation system 100, and not in the other direction. The forward pressure regulator 136 may include a pressure sensor or may be passively configured to maintain a specific pressure on the downstream side of the forward pressure regulator 136 (i.e., on the side that connects to the path of the flow of oxygen and water 114).

As noted above, the cell stack 102 is configured as an anode-feed system, with the input water 108a being directed into the anode 104 (or a cavity thereof). To ensure proper operation of such a system, the oxygen generation system 100 includes a set of flow controllers 140a, 140b, 140c, which are arranged along the water flow paths of the oxygen generation system 100. The flow controllers 140a-c may be settable orifices, controllable valves, preset or fixed valves, one-way valves, fixed orifices, adjustable orifices or valves, or the like. It will be appreciated that reverse flow may be desirable at some transient instances, such as after shut-down, such that water may backfill or make up space or volume to account for hydrogen that has been removed. Accordingly, the flow controllers 140a-c may be configured to allow some amount of back or reverse flow.

As shown, an anode-side flow controller 140b is arranged along the anode-side flow of water 108b, a cathode-side flow controller 140c is arranged along the cathode-side flow of water 108b, and an input flow controller 140a is arranged along the flow of input water 108a. The anode-side flow controller 140b is arranged downstream from the anode-side phase separator 116 and upstream from a water control assembly 142, wherein the anode-side flow of water 108b and the cathode-side flow of water 108c are joined to form the input water 108a. Similarly, the cathode-side flow controller 140c is arranged downstream from the cathode-side phase separator 126 and upstream from the water control assembly 142. The input flow controller 140a is arranged between the water control assembly 142 and the stack inlet 110 of the cell stack 102. The water control assembly 142 includes a volume compensation device 144 and a pump 146. The pump 146 is configured to pump the water 108 through the oxygen generation system 100 and generate a pressure for flow of water 108 within the oxygen generation system 100. The volume compensation device 144 is provided to accommodate changes in volume of the water 108 (e.g., whether due to thermal impacts, added or removed water from the water source 134, and/or the consumption or generation of water on shutdown and/or startup). The volume compensation device 144 may be an accumulator, a variable volume container, a bellows-assembly, or the like, as will be appreciated by those of skill in the art.

A controller 148 is provided to control operation of the oxygen generation system 100. The controller 148 may include various components and elements, such as a power supply, input/output connections, electrical wiring, processors, and the like, as will be appreciated by those of skill in the art. The controller 148 may be operably connected to and/or in communication with, at least, the cell stack 102 and the water control assembly 142, and in some embodiments, the forward pressure regulator 136. It will be appreciated that in some configurations, the cell stack may be provided with a dedicated power supply that may be separate and distinct from a general power supply onboard a craft or the like. In some embodiments, the cell stack power supply or other power supply separate therefrom may be used to power various components of the system 100, including the controller 148 and provide power to fans, actuators, sensors, and the like, as will be appreciated by those of skill in the art. The controller 148 is configured to control operation of the oxygen generation system 100 to generate oxygen and to ensure safe operation of the oxygen generation system 100. In some embodiments, the controller 148 may be configured to control operation of the pump 146, the cell stack 102, and, optionally, the forward pressure regulator 136, with other features of the system 100 being passively or actively operated. The control of the pump 146 may be performed to cycle water 108 through the oxygen generation system 100 and control of the cell stack 102 may be performed to supply electrical power to the cell stack 102 and cause electrolysis and separation of water into hydrogen and oxygen. The controller 148 may also be configured to control operation of the forward pressure regulator 136 to ensure sufficient amounts of water and water pressure are maintained within the oxygen generation system 100.

In order to monitor the oxygen generation system 100, the controller 148 may be arranged in communication with one or more sensors arranged about the oxygen generation system 100. For example, various pressure sensors 150a-f may be arranged to monitor pressure at inlets and outlets and/or upstream and downstream positions relative to components of the oxygen generation system 100. In this illustrative configuration, the oxygen generation system 100 includes a first pressure sensor 150a arranged at the stack inlet 110 of the cell stack 102, and thus the inlet to the anode 104 of the cell stack 102. A second pressure sensor 150b is arranged at the anode outlet 112, a third pressure sensor 150c is arranged at an outlet of the anode-side phase separator 116 along the anode-side flow of water 108b, and a fourth pressure sensor 150d is arranged along a flow path of the gaseous oxygen 118 that is separated and output from the anode-side phase separator 116. On the cathode side of the oxygen generation system 100, a fifth pressure sensor 150e is arranged along the cathode-side flow of water 108c at a position downstream from the cathode-side phase separator 126, and a sixth pressure sensor 150f is arranged along a flow path of the gaseous hydrogen 130 that is separated and output from the cathode-side phase separator 126. In this configuration, the flow path of the gaseous oxygen 118 may also include a hydrogen sensor 152 arranged to monitor if hydrogen is mixed with the gaseous oxygen 118, for safety purposes. That is, it may be undesirable to have hydrogen be directed through the oxygen outlet 120 as such free hydrogen may pose safety risks. Accordingly, the controller 148 may be configured to shut down operation of the system if a threshold concentration of hydrogen is detected with the gaseous oxygen 118 that is output from the oxygen generation system 100.

The oxygen generation system 100 may be described herein relative to an anode loop and a cathode loop, although the two loops join together at the water control assembly 142 to form the input water 108a that is input to the anode 104 at the stack inlet 110 of the cell stack 102. As such, although two separate loops are provided within the oxygen generation system 100, the two loops are fluidly coupled and share a common water output where the water flows of the two loops are joined together (water control assembly 142) and then cycled back to the start of each loop within the cell stack 102.

The anode loop extends from the anode 104, through the anode outlet 112 as a flow of the oxygen and water 114 (a two-phase fluid) which is directed to the anode-side phase separator 116. The resupply junction 138 is arranged along this portion of the anode loop (the two-phase portion) and allows for resupply or makeup water 108d to be mixed with the oxygen and water 114 that is directed to the anode-side phase separator 116. Along the anode loop, water 108b exits the anode-side phase separator 116 and is directed to the water control assembly 142, where the water is then directed back to the anode 104 at the stack inlet 110 of the cell stack 102. The gaseous oxygen 118 is removed from the two-phase flow of oxygen and water 114 at the anode-side phase separator 116.

The cathode loop extends from the cathode 106, through the cathode outlet 122 as a flow of the hydrogen and water 124 (a two-phase fluid) which is directed to the cathode-side phase separator 126. As noted above, because this two-phase fluid includes gaseous hydrogen (hydrogen and water 124), the control volume path 128 is arranged to limit the duration and volume in which gaseous hydrogen may be present. Along the cathode loop, water 108c exits the cathode-side phase separator 126 and is directed to the water control assembly 142, where the water is then directed back to the anode 104 at the stack inlet 110 of the cell stack 102. The gaseous hydrogen 130 is removed from the two-phase flow of hydrogen and water 124 at the cathode-side phase separator 126.

In operation of the oxygen generation system 100, flow across the flow controllers 140a-c ensures that the pressure of the fluids within the system (e.g., water, gaseous hydrogen, gaseous oxygen, and mixtures thereof) are maintained at operational pressures. For example, the flow controllers 140a-c are arranged and set to ensure that the two-phase flows (flow of oxygen and water 114 and flow of hydrogen and water 124) are maintained at pressures that are higher than the respective gaseous flows (gaseous oxygen 118 and gaseous hydrogen 130). As such, the gaseous components from the two-phase flows 114, 124 will flow through the respective phase separators 116, 126 and exit toward the respective outlets 120, 132. The phase separators 116, 126 may be arranged as membrane contactors, which permit the respective gases to be separated from the two-phase flows, and resulting in water 108b, 108c to be recycled within the oxygen generation system 100, as illustrated. The flow controllers 140a-c are also set to ensure that the cathode side of the oxygen generation system 100 is kept at pressure higher than the anode side of the oxygen generation system 100. The forward pressure regulator 136 is arranged to supply continuous resupply water 108d into the oxygen generation system 100 to make up for and replace water that has been electrolyzed into gaseous hydrogen and oxygen, which exit the oxygen generation system 100 via the phase separators 116, 126 as gaseous oxygen 118 and gaseous hydrogen 130.

During a shutdown operation, the electrolysis operation within the cell stack 102 is halted. This stoppage may be initiated by the controller 148 automatically, such as based on sensor readings and/or a scheduled operation. In other operations, the controller 148 may be toggled or operated by user input, such as using an on/off switch or the like. The shutdown of the electrolysis operation may be achieved by stopping a supply of electrical current to the cell stack 102. With the electrolysis operation stopped, circulation of flow through anode loop is continued, such as by operation of the pump 146, which forces water to circulate through the anode loop. The continued operation of the pump 146 causes the flow of oxygen and water 114 to be passed into and through the anode-side phase separator 116 to ensure that the gaseous oxygen is removed from the water. During this process, the result is that only water (without two-phase fluid) is present in the anode loop (from the anode outlet 112 to the stack inlet 110, and including the inside volume of the anode 104 of the cell stack 102). Further, during the shutdown operation, the flow of hydrogen and water 124 is contained within a relatively short length and/or small volume of the control volume path 128. In accordance with some configurations and operations, the control volume path 128 may be configured to ensure that gaseous hydrogen is limited in opportunity to leak and/or accumulate to critical concentrations. That is, the control volume path 128 may be configured to minimize leakages during operation and to maintain a relatively small volume or concentration within the system at the time of shutdown. The control volume path 128 may be configured and sized based on a number of factors, including without limitation, pressures, ventilation (e.g., airflow ventilation), detection sensitivity, shutdown timing, production rate, and the like.

During startup operations, the volume compensation device 144 of the water control assembly 142 is provided to accommodate expansion or contraction of fluids within the oxygen generation system 100. At startup, the controller 148 will supply electrical current to the cell stack 102 to initiate or restart electrolysis and separation of water into gaseous hydrogen and oxygen. During this startup operation, the volume of fluid within the system will increase. The volume compensation device 144 is provided to accommodate such increase in volume, and the volume compensation device 144 will reduce in size as the volume stabilizes as the operation enters a stable state. It is noted that the volume compensation device 144 may also accommodate extra or added water that is introduced from the water replenishment system 133.

As noted above, a set of flow controllers 140a-c are provided to ensure that the flow through the oxygen generation system 100 is in the proper direction (e.g., prevent or minimize backflow or the like during operation). For example, to ensure proper phase separation within the oxygen generation system 100 and to cause the gases 118, 130 to exit through the phase separators 116, 126, the forward pressure regulator 136, the pump 146, and the set of flow controllers 140a-c may be controlled or have preset characteristics to maintain various pressure differentials throughout the oxygen generation system 100. The passive and/or active control results in a fluid flow in the anode loop from the anode outlet 112, through the anode-side phase separator 116, and back to the stack inlet 110, and along the cathode loop, the flow direction is from the cathode outlet 122, through the cathode-side separator 126, and then back to the stack inlet 110. In accordance with some embodiments, it may be desirable to permit some amount of backflow, such as during a state of power loss. For example, use of orifices that permit two-way flow (but may be preferential in one direction), allows for pressure equalization during loss of power (e.g., power loss or shutdown). Accordingly, it will be appreciated that the flow controllers 140a-c are not limited to only one-way flow, and in some configurations it may be preferred to permit two-way flow.

From the perspective of fluid flow along the anode loop, the fluid pressure of the flow of the oxygen and water 114 is maintained at a relatively high pressure by means of the anode-side flow controller 140b and the forward pressure regulator 136. The forward pressure regulator 136 may introduce resupply water 108d from the water source 134 to ensure that a pressure upstream and downstream of the anode-side phase separator 116 (sensor 150b and sensor 150c, respectively) is higher than a pressure at the outlet of the gaseous oxygen 118 from the anode-side phase separator 116 (sensor 150d). In some non-limiting embodiments, the anode-side flow controller 140b may provide a passive mechanism to generate a pressure differential (e.g., an orifice or the like). In other embodiments, the anode-side flow controller 140b may be a controllable valve or the like. As a result, the water pressure of the water 108b that is output from the anode-side phase separator 116 is controlled by the anode-side flow controller 140b to be greater than a pressure of the gaseous oxygen 118 that is output from the anode-side phase separator 116 (i.e., pressure at sensor 150b, 150c is greater than pressure at sensor 150d). Similarly, the forward pressure regulator 136 is set to be greater than a pressure of gaseous hydrogen 130 that is output from the cathode-side phase separator 126 (i.e., pressure at sensor 150b is greater than pressure at sensor 150f). To ensure that the gaseous oxygen 118 does not stay entrained in the anode-side flow of water 108b and to ensure proper phase separation of liquid water (108b) and the gaseous oxygen 118, a pressure at the water outlet side of the anode-side phase separator 116 is maintained to be higher than a pressure of the gaseous oxygen 118 (i.e., pressure at sensor 150c is greater than pressure at sensor 150d). This pressure differential may be controlled, in part, by the anode-side flow controller 140b.

It is noted that because the anode loop and the cathode loop are fluidly coupled, the pressure at the anode outlet 112 (sensor 150b) is controlled to be greater than a pressure at the outlet of the gaseous hydrogen 130 (sensor 150f). As a result, the highest pressure location within the oxygen generation system along the flow path of the flow of oxygen and water 114, and may be augmented by introduction of resupply water from the water source 134 by operation of the forward pressure regulator 136. The pressure at the sensor 150b at the anode outlet 112 may be controlled, in part, by a setpoint of the forward pressure regulator 136.

To ensure cathode-side separation of gaseous hydrogen 130 from the flow of hydrogen and water 124, the cathode-side flow controller 140c is set (e.g., passively set or actively controlled) to ensure that the pressure of the water 108c in the cathode loop (sensor 150e) is greater than a pressure of the gaseous hydrogen 130 that exits the oxygen generation system 100 (sensor 150f). Further, to ensure leak detection of hydrogen within the oxygen generation system 100, the input flow controller 140a may be set or controlled to ensure that a pressure of the cathode 106 is greater than a pressure at the anode outlet 112 (sensor 150b). The pressure of the cathode 106 may be monitored by a sensor (not shown for clarity), that is arranged at the outlet of the cathode 106, such as within or along the control volume path 128. By ensuring that the cathode 106 is at a higher pressure than the anode outlet 112, free oxygen will be prevented from entering the cathode loop, and will be directed into the anode loop, and may be removed at the anode-side phase separator 116. Moreover, in the event of hydrogen separation failures, the cathode loop is cycled back to the stack inlet 110 which is on the anode 104 (i.e., the output of the cathode 106 is fluidly connected to the input of the anode 104). This configuration and arrangement provides for a controlled recombination at the catalyst site during electrolysis (i.e., within the cell stack 102) and/or if any gaseous hydrogen is picked up by the anode loop fluids, it may be detected by the hydrogen sensor 152 arranged between the anode-side phase separator 116 and the oxygen outlet 120.

As noted above, a pre-filling of water may be employed. That is, the oxygen generation system 100 may initially be filled with water from the water source 134, and the pump 146 may be operated to achieve the above described pressure conditions (e.g., monitor the sensors 150a-f to achieve the desired pressure differentials). When the pressure within the oxygen generation system 100 is achieved, the pump 146 will continue to operate to cycle water and two-phase fluids through the anode loop and the cathode loop, as described above. The controller 148 may then initiate electrolysis within the cell stack 102 by supplying electrical current to the cell stack 102. The volume compensation device 144 is provided to allow for the pre-filling or pre-charging of liquid water and then expansion that occurs when electrolysis is started. Because it is desirable to keep the oxygen separation system 100 in a water-filled state, even when turned off or in a dormant state, at shutdown, the electrolysis at the cell stack 102 is stopped and the pump 146 is operated to cycle fluids through the loops of the oxygen generation system 100. This will result in the gaseous oxygen 118 to be extracted at the anode-side phase separator 116. As the gaseous oxygen 118 is removed during this shutdown operation, the water replenishment system 133 may provide resupply water 108d into the system to make up for the volume of gaseous oxygen 118 that leaves the system during shutdown, and thus pressures within the system may be maintained. The control volume path 128 between the cell stack 102 and the cathode-side phase separator 126 ensures that a volume of gaseous hydrogen that stays within the system is kept within safe concentration limits.

In accordance with embodiments of the present disclosure, the use of flow controllers (e.g., flow controllers 140a-c), volume compensation devices (e.g., volume compensation device 144, pumps (e.g., pump 146) ensure that the phase separators (e.g., phase separators 116, 126) remain filled with liquid water under all operating condition (both active oxygen generation and in a dormancy or off state). This continuous or perpetual filling or charging with liquid water allows for the use of membrane contact separators for both the anode loop and the cathode loop. Furthermore, the use of the flow controllers, volume compensation device, and pump allow for the elimination of a purge gas system, which is used in conventional systems. Rather, purging is achieved through pumping liquid water through the oxygen separation system 100 during an off-state of the cell stack (i.e., no electrolysis). This pumping of liquid water will cause entrained gases to be removed from the fluid flows at the respective phase-separators (e.g., phase separators 116, 126). In accordance with some embodiments, the flow controllers 140a-c may be configured to permit flow in both directions (i.e., not one-way), so that the cathode-side separator 126 stays charged or filled with water. The ability to reverse-flow at the various flow controllers 140a-c allows water pressure at the fifth pressure sensor 150e to stay above the hydrogen pressure at the sixth pressure sensor 150f. As a result of this pressure differential, hydrogen gas will evacuate through the membrane of the cathode-side phase separator 126 and water will backfill in its place.

In some embodiments, an optional sweep flow 154 may be supplied into the oxygen portions of the anode-side phase separator 116. The sweep flow 154 may be a gas or may be ambient air (e.g., air from a surrounding cabin or occupied space). The sweep flow 154 may be provided to aid in oxygen flow across the membrane and/or to manage humidity (e.g., to keep relative humidity low on the gas side of the phase separator 116). For example, the sweep flow 154 may aid in transportation of oxygen because it can enhance the partial pressure of the oxygen gradient. The sweep flow 154 may be controlled by the controller 148, using a pump, fan, or other motive driver, or though opening of an orifice or the like, and relying on a pressure differential to sweep the sweep flow 154 through the anode-side phase separator 116 and out of the oxygen separation system 100.

It is noted that a major difference between the conventional cathode-feed configurations and the anode-feed configurations of the present disclosure, is the presence of liquid water in both the oxygen and hydrogen streams that are output from the cell stack. In some example operational arrangements, in accordance with the present disclosure, the quality of the two-phase flow (e.g., flow of oxygen and water 114) along the oxygen side output, is approximately 30-50% gas by volume depending on the water flow rate. In the case of the hydrogen side output, the quality of the two-phase flow (e.g., flow of hydrogen and water 124) is greater than 99% gas by volume and constant regardless of production rate if permeation losses are neglected. The recirculation water flow rate, which impacts the two-phase quality on the anode side, is determined based on two basic requirements: heat rejection and gas removal. While water must be supplied at sufficient rates to support electrolysis, the rate of water consumption through the reaction is orders of magnitude lower than the required flow to prevent overheating of the cells or to prevent gas binding and subsequent dry out. As such, the circulated water, through both the anode loop and the cathode loop provides a mechanism for cooling the system, while also ensuring electrolysis and oxygen generation during operation.

In additional to changing the approach to oxygen generation through use of flow controllers and a water supply that keeps liquid water within the system, some embodiments of the present disclosure change the nature of hydrogen gas management as compared to prior systems. In prior low-gravity systems, the systems may include containment mechanisms to ensure that free hydrogen does not leak and/or reach concentrations that may pose risks within an enclosed space or environment (e.g., onboard a spacecraft). The containment mechanisms typically include a pressure vessel or the like (e.g., dome) that houses the structures through which free hydrogen is directed (e.g., downstream from a hydrogen output of a cell stack).

In prior oxygen generation systems, external leakage hazard severity was qualitative, based on the internal fluid alone and was centered on preventing leaks. As a result, dual-seal and even triple-seal configurations were employed to ensure that hydrogen gas would not leak from the system. Furthermore, such seal configurations were subject to rigorous design measures related to the seal and groove design and processing thereof, to ensure leak prevention. However, in accordance with embodiments of the present disclosure, instead of basing hazard severity on the fluid alone, where it was assumed a leak would automatically manifest a hazard, now the actual leak rates are taken into account, allowing for less extreme hydrogen-safety measures (e.g., less costly, less complex, reduced weight, fewer components, etc.). That is, in accordance with some embodiments of the present disclosure, a maximum credible leak (MCL), which is defined as a worst-case leak rate, is compared to a maximum allowable leak (MAL), which is defined as a maximum leak rate before a critical or catastrophic hazard is induced. This comparison is made in order to determine if a hazard can be induced by a leak (e.g., a detected leak rate). Although this approach, as described herein, does not necessarily do away with the old approach, it may build off of it. That is, in accordance with some embodiments of the present disclosure, quantitative limits or thresholds are established for a given fluid (e.g., hydrogen), and performing actions in response to detected concentrations of fluids, such as hydrogen gas. Accordingly, the prevention of leaks may not be strictly required (e.g., use of dome that contains hydrogen), but rather embodiments of the present disclosure are directed reducing and/or limiting a leak such that accumulation of the fluid (e.g., hydrogen) does not result in the manifestation of a hazardous affect (e.g., excessive hydrogen accumulation).

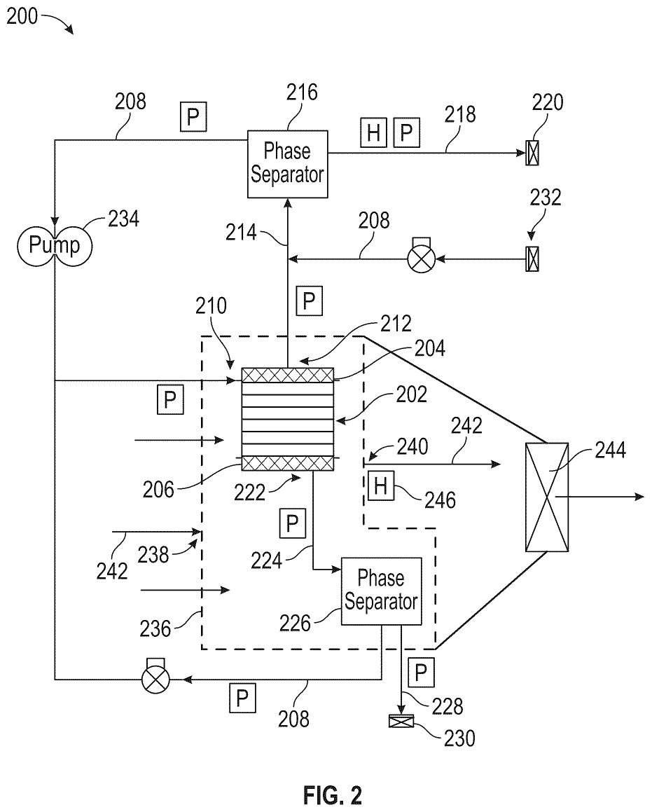

Referring now to FIG. 2, a schematic diagram of an oxygen generation system 200 in accordance with an embodiment of the present disclosure is shown. The oxygen generation system 200 may be used in low-gravity environments, such as onboard spacecraft, space stations, vehicles or structures located in low-gravity environments, and the like. The oxygen generation system 200 is configured as an anode-feed system, similar to the configuration shown and described with respect to FIG. 1. The oxygen generation system 200 includes a cell stack 202 with an anode 204 and a cathode 206. Similar to the configuration of FIG. 1, water 208 is fed into the anode 204 at a stack inlet 210 of the cell stack 202 and electrolyzed into two output flows. At an anode outlet 212 of the cell stack 202, the oxygen generation system 200 outputs a flow of oxygen and water 214 which is directed to an anode-side phase separator 216. The flow of oxygen and water 214 is separated into component parts by the anode-side phase separator 216, resulting in an anode-side flow of water that is directed back to the cell stack 202, as described above. The oxygen of the flow of oxygen and water 214 is separated by the anode-side phase separator 216 and output as gaseous oxygen 218, which is directed to an oxygen outlet 220. The oxygen outlet 220 may be fluidly connected to a cabin or other occupied space for breathing and/or may be fluidly connected to a storage container or the like for storing gaseous oxygen (e.g., for medical uses, fuel, or for other purposes as will be appreciated by those of skill in the art).

At the cell stack 202, the second output flow is directed through a cathode outlet 222 of the cell stack 202. A flow of hydrogen and water 224 is directed from the cathode outlet 222 to a cathode-side phase separator 226. The flow of hydrogen and water 224 is separated into component parts by the cathode-side phase separator 226, resulting in a cathode-side flow of water that is directed back to the cell stack 202, as described above. As discussed above, the flow of hydrogen and water 224 may be directed through a control volume path (i.e., fixed volume). The hydrogen of the flow of hydrogen and water 224 is separated by the cathode-side phase separator 226 and output as gaseous hydrogen 228, which is directed to a hydrogen outlet 230. The hydrogen outlet 230 may be fluidly connected to a vent to evacuate the hydrogen and/or may be fluidly connected to a storage container or the like for storing gaseous hydrogen (e.g., for fuel or for other purposes as will be appreciated by those of skill in the art).

The oxygen generation system 200 further includes a water replenishment system 232 for adding water 208 into the system and to maintain fluid pressures, as described above. The oxygen generation system 200 may also include a pump 234, that is operated to generate a motive force to cycle the fluids (e.g., liquid water and gaseous oxygen and hydrogen) through the oxygen generation system 200. The oxygen generation system 200 may also include various pressure sensors, gas sensors (e.g. hydrogen sensors), a controller, and associated components, as shown and described above. Furthermore, the oxygen generation system 200 may include one or more of the flow controllers arranged about the anode loop, the cathode loop, and the joining of the two loops upstream of the cell stack 202, as shown and described above with respect to FIG. 1.

The oxygen generation system 200 of FIG. 2 is illustrated with a hydrogen management system that is different from prior configurations and systems. In the illustrated configuration of FIG. 2, the containment assembly of a traditional oxygen generation system (i.e., a dome), is replaced with an approach that uses sensors and a ducting system. That is, in accordance with some embodiments of the present disclosure, a substantially open configuration that does not rely upon sealed containers is implemented. In such configurations, the components of the oxygen generation system 200 that contain hydrogen (e.g., the cell stack 202, the flow of hydrogen and water 224, the cathode-side phase separator 226, and associated flow paths) are arranged in a ducting system 236. The ducting system 236 may be substantially open-ended, having a duct inlet 238 and a duct outlet 240, with the cell stack 202, the flow of hydrogen and water 224, the cathode-side phase separator 226, and associated flow paths arranged within the ducting system 236 between the duct inlet 238 and the duct outlet 240. The ducting system 236 may be formed of one or more ducts or flow passages that are substantially contained or enclosed with open ends at the ducting inlet 238 and the duct outlet 240.

In operation, a vent air stream 242 is directed into the ducting system 236 and the airflow will pass over the components within the ducting system 236. As such, any leakage of gases, and particularly free hydrogen, may be picked up by the vent air stream 242 and carried out of the ducting system 236. The vent air stream 242 may be induced by a fan 244 or similar device, which may pull the vent air stream 242 through the ducting system 236. As shown, the fan 244 may be arranged at the end of a funnel structure of the ducting system 236. In other configurations, a fan or similar device may be used to push the vent air stream 242 through the ducting system 236, and/or a combination of push and pull may be employed. Furthermore, although described as a fan, it will be appreciated that other types of motive drivers may be used to direct a flow of air through a ducting system without departing from the scope of the present disclosure. For example, and without limitation, other motive drivers may include induced pressure differential(s), vent systems to vacuum, blowers, or the like.

The vent air stream 242 is monitored by, at least, a hydrogen sensor 246 arranged at the outlet 240 of the ducting system 236. The hydrogen sensor 246 may be operably connected to a controller or the like (e.g., controller 148 shown in FIG. 1; not shown in FIG. 2 for simplicity). The hydrogen sensor 246 may be arranged to monitor concentrations of hydrogen within the vent air stream 242 after the vent air stream 242 has passed over the components of the system 200 arranged within the ducting system 236, and thus picked up any free hydrogen (or other gases) that may have leaked from the system 200. The controller will monitor concentrations of hydrogen that are detected at the outlet 240 of the ducting system 236. If a hydrogen concentration is detected at a concentration that meets or exceeds a threshold or predetermined value, the controller may be configured to stop oxygen production at the cell stack 202, such as by stopping a supply of electrical current to the cell stack 202. Furthermore, in some embodiments, the controller may control the fan 244 to increase the amount or rate of the vent air stream 242 through the ducting system 236, to assure pickup, removal, and dilution of the free hydrogen. The vent air stream 242 may be sourced from a surrounding environment, such as an occupied space, and thus may be a mixture of breathable air. As the vent air stream 242 flows through the ducting system 236, the moving air will pick up any free hydrogen and carry it out of the ducting system 236. This action will both remove the free hydrogen from within the ducting system 236 and will serve to dilute the free hydrogen such that it is reduced to concentrations that are below the threshold value. In some embodiments, the controller and hydrogen sensor 246 may be used to ensure that the hydrogen concentrations are below a lower threshold value prior to restarting oxygen generation within the cell stack 202.

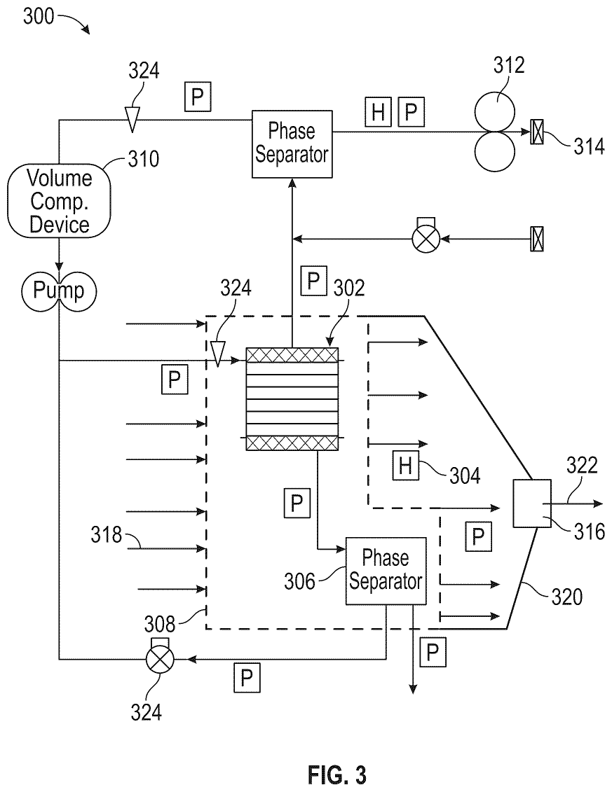

Referring now to FIG. 3, a schematic diagram of an oxygen generation system 300 in accordance with an embodiment of the present disclosure is shown. The oxygen generation system 300 may be used in low-gravity environments, such as onboard spacecraft, space stations, vehicles or structures located in low-gravity environments, and the like. The oxygen generation system 300 is configured as an anode-feed system, similar to the configurations shown and described with respect to FIGS. 1-2. The oxygen generation system 300 includes a cell stack 302 with an anode and a cathode. Water is fed into the anode and electrolyzed into two output flows, with a mixture of oxygen and water being directed along an anode loop and a mixture of hydrogen and water being directed along a cathode loop. The two mixtures may be separated into the component parts such that the gases are removed (either captured, stored, reused, or vented) and the liquid (i.e., water) is recycled and/or recirculated within the system 300.

Similar to the configuration of FIG. 2, the oxygen generation system 300 of FIG. 3 is illustrated with a hydrogen management system. In the illustrated configuration of FIG. 3, the hydrogen management system includes one or more hydrogen sensors 304, with the cell stack 302 and a hydrogen phase separator 306 arranged within a ducting system 308. In this configuration, the system 300 includes an accumulator 310. The accumulator 310 may be part of a water control assembly (e.g., water control assembly 142 shown in FIG. 1). The accumulator 310 is configured to accommodate excess water within the system 300 and may provide, for example, similar functionality as the volume compensation device 144 of FIG. 1. The accumulator 310 may be incorporated into various systems described herein, and may be used, for example, if the phase separators are not rotary separators, as rotary separators inherently have accumulator functionality. As such, it will be appreciated that in any of the above described embodiments, if a non-rotary separator is used for the phase separation, the system may include an accumulator similar to the accumulator 310 shown in FIG. 3.

Further, as shown, the system 300 includes an optional compressor 312 arranged along an output path of gaseous oxygen, which is directed to an oxygen outlet 314. The compressor 312 may be a mechanical compressor, an electrochemical compressor, or combinations thereof. Furthermore, one or more compressors may be arranged along the oxygen flow path, as will be appreciated by those of skill in the art. The compressor 312 may be used to boost a pressure of the gaseous oxygen, which boost a pressure of the gaseous oxygen for storage and/or medical use purposes. In other configurations, the compressor 312 may be replaced with a collector and/or a combination of a compressor and a collector, as necessary for the specific configuration and application.

Additionally, as shown in FIG. 3, the system 300 includes an optional recombiner 316. The recombiner 316 may be provided to receive a vent air stream 318 that is passed through the ducting system 308. The ducting system 308 may include a funnel structure 320 at an outlet side thereof, which is used to funnel and direct the vent air stream 318 to the recombiner 316. As such, the ducting system 308 is configured to direct all the vent air stream 318 and any collected hydrogen (or other gases) from the components arranged within the ducting system 308 into the recombiner 316. That is, any leaked fluids (e.g., hydrogen, oxygen, water vapor, etc.) that may escape and/or leak from the components of the system within the ducting system 308 may be captured and directed away from the point of leakage and through the ducting system 308 to the recombiner 316. Any free hydrogen and oxygen that are carried by the vent air stream 318 will be recombined into water vapor within the recombiner 316. The captured water vapor, the recombined water vapor, and the vent air stream 318 (e.g., mixture of air and water) can be returned to a surrounding environment (e.g., cabin) as indicated at arrow 322, and may be free of trace hydrogen. Additionally, as shown, the system 300 may include one or more flow controllers 324, arranged about the various flow paths/loops of the system 300, similar to the flow controllers shown and described with respect to FIG. 1.

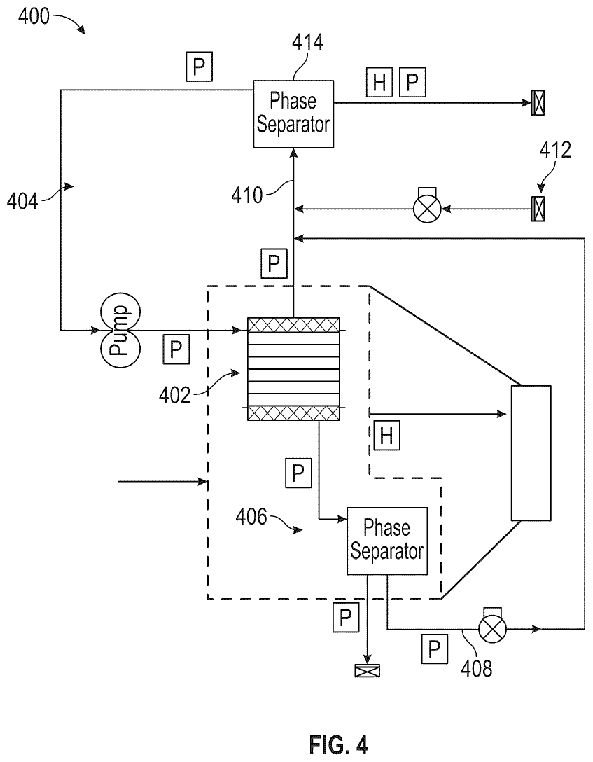

Referring now to FIG. 4, a schematic diagram of an oxygen generation system 400 in accordance with an embodiment of the present disclosure is shown. The oxygen generation system 400 may be used in low-gravity environments, such as onboard spacecraft, space stations, vehicles or structures located in low-gravity environments, and the like. The oxygen generation system 400 is configured as an anode-feed system, similar to the configurations shown and described above. The oxygen generation system 400 includes a cell stack 402 with an anode and a cathode. Water is fed into the anode and electrolyzed into two output flows, with a mixture of oxygen and water being directed along an anode loop 404 and a mixture of hydrogen and water being directed along a cathode loop 406. The two mixtures may be separated into the component parts such that the gases are removed (either captured, stored, reused, or vented) and the liquid (i.e., water) is recycled and/or recirculated within the system 400. In this configuration, output water 408 from the cathode loop 406 may be directed to combine with a flow of oxygen and water 410 of the anode loop 404. This alternative configuration allows for the output water 408 from the cathode loop 406 to supplement the water supply in the anode loop 404. This can result in less activation of a water replenishment system 412 for the purpose of controlling fluid pressures within the anode loop 404. It will be appreciated that the water replenishment system 412 may still be operated to replenish lost water from operation of the system, as described above. Further, the water replenishment system 412 may be still be operated to ensure necessary operational pressures within the system 400. The combined flow of oxygen and water 410 will be directed into a anode-side phase separator 414, as described above, to extract oxygen therefrom.

In view of the above illustrative embodiments and configurations, it will be appreciated that various components and elements may be interchanged to achieve a desired oxygen generation system for a specific application. For example, the safety features provided by a ducting system may be used in any of the above described embodiments and variations thereon. Further, the other features and components of the embodiments may be combined without departing from the scope of the present disclosure. For example, and without limitation, any of the above described components, such as the ducting system, recombiners, accumulators, compressors, fans and motive drivers of the vent air stream, various flow controllers, pressure sensors, gas or fluid sensors, and the like may be combined in other arrangements and combinations, without departing from the scope of the present disclosure.

In accordance with embodiments of the present disclosure, oxygen generation systems for use in low-gravity environments are provided. The systems described herein may provide for improved or efficient oxygen generation while reducing overall costs, complexity, maintenance. In accordance with some embodiments, a conventional cathode feed electrolyzer is replaced by a less expensive, and more reliable anode feed electrolyzer. This configuration eliminates the need for rotary separators, which are typically required for low-gravity environments. The use of membrane-separators for both hydrogen and oxygen fluid separation (from water) reducing the moving parts and complexity of the phase separators, thereby simplifying the system. The combination of membrane phase separators and an anode feed system results in a unique liquid-water based system, where liquid water is present in both the anode loop and the cathode loop, and makeup water in combination with pumps or the like are used to keep fluid pressures at necessary levels to ensure electrolysis within a cell stack and ensure complete separation within the phase separators. The pressure levels may be maintained, for example, by the inclusion of various flow controllers arranged about the anode loop and the cathode loop. Pressure differentials may be induced or set by the respective flow controllers to ensure that oxygen generation is maintained while reducing the risks associated with free hydrogen. For example, the liquid water may be used to displace free gasses and remove them from the system (e.g., at the respective phase separators).

Furthermore, advantageously, safety may be improved while also reducing the complexity of the system. For example, in accordance with some embodiments, a ducting system is employed to replace the conventional dome containment systems for free hydrogen. The ducting system may simplify the system by locating various components within one or more ducts, flow passage(s), or the like. For example, the cell stack, a hydrogen-water flow path, a hydrogen-gas phase separator, and a hydrogen outlet therefrom, may be arranged within the ducting system. As such, any hydrogen that leaks or escapes from the components that contain gaseous hydrogen will pass into the ducting system. Because the ducting system will have a flow of air through the ducts and/or flow passages thereof, the escaping hydrogen will be picked up by the moving air and removed from the ducting system. As such, the ducting system provides at least two mechanisms for hydrogen safety. First, the ducting system and driven airflow will ensure that the free or escaped hydrogen is removed from the immediate source, thus reducing the likelihood of dangerous concentrations. Secondly, because the ducting system is provided with a moving airflow, the air of the airflow will result in dilution of the concentration of hydrogen, ensuring that the concentration of hydrogen does not accumulate to a hazardous level. However, even with such safety mechanisms, a hydrogen leak may occur where hydrogen amount reach a threshold concentration, which may be a concentration that is below a hazardous concentration of hydrogen. When the threshold concentration of hydrogen is detected in the airflow, a controller may be used to shut down or stop oxygen generation in a cell stack (which results in hydrogen generation as well, due to electrolysis of water). With the electrolysis stopped, hydrogen generation will be stopped, and the excess hydrogen may be diluted/or and removed from the ducts, flow passages, and the like of the ducting system, thus bringing the hydrogen concentration back to acceptable levels. The electrolysis may be restarted once the hydrogen concentration is below the threshold value, or below a lower threshold value which is different from the initial hydrogen threshold value used to shut down electrolysis.

In some configurations, advantageously, the systems may include accumulators or volume compensation devices to accommodate changes in volume within the system. This may be particularly useful because the system is filled with water, and during start-up and shut-down the fluid volume within the system may change. The volume compensation devices and/or accumulators may be provided to accommodate changes in volume. The continuous cycling of water through the system may operate to entrain free gases and cycle them back to the cell stack. That is, the water may function as a sweep fluid to ensuring gas concentrations remain below levels that may pose a risk. Furthermore, the supply of water may be used to pre-fill the system so that electrolysis is ensured throughout operation of the oxygen generation systems described herein. These and other advantages and benefits of the disclosed systems will be appreciated by those of skill in the art in view of the above description and accompanying illustrations.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An oxygen generation system for use in low-gravity environments, the oxygen generation system comprising:
a cell stack having an anode and a cathode, wherein the anode is configured to receive liquid water as an input at a stack inlet and output a mixture of liquid water and gaseous oxygen and wherein the cathode is configured to output a mixture of liquid water and gaseous hydrogen;
an anode-side phase separator fluidly coupled to an outlet of the anode, wherein the anode-side phase separator is configured to separate the mixture of liquid water and gaseous oxygen into liquid water and gaseous oxygen, wherein the gaseous oxygen is directed to an oxygen outlet;
a cathode-side phase separator fluidly coupled to an outlet of the cathode, wherein the cathode-side phase separator is configured to separate the mixture liquid water and gaseous hydrogen into liquid water and gaseous hydrogen, wherein the gaseous hydrogen is directed to a hydrogen outlet;
a ducting system configured to house the cell stack and the cathode-side phase separator;
a hydrogen sensor arranged at an outlet of the ducting system; and
a controller configured to stop oxygen generation at the cell stack when a concentration of hydrogen is detected at or above a threshold level at the hydrogen sensor at the outlet of the ducting system.

2. The oxygen generation system of claim 1, further comprising a fixed-volume path between the cathode and the cathode-side phase separator, wherein the fixed-volume path is arranged within the ducting system.

3. The oxygen generation system of claim 1, further comprising a fan arranged to generate a flow of air through the ducting system.

4. The oxygen generation system of claim 1, further comprising a water control assembly arranged to receive and combine the liquid water from each of the anode-side phase separator and the cathode-side phase separator, and direct the combined liquid water back to the stack inlet.

5. The oxygen generation system of claim 4, wherein the water control assembly comprises a pump operable to circulate water through the system.

6. The oxygen generation system of claim 4, wherein the water control assembly comprises an expansion device configured to accommodate expansion of fluid volume within the system.

7. The oxygen generation system of claim 1, further comprising a recombiner arranged to receive hydrogen output from the hydrogen phase separator.

8. The oxygen generation system of claim 1, further comprising:
an anode-side flow controller arranged between the anode-side phase separator and the water control assembly, the anode-side flow controller configured to cause a pressure differential such that an upstream side of the anode-side flow controller is at a greater pressure than a downstream side of the anode-side flow controller;
a cathode-side flow controller arranged between the cathode-side phase separator and the water control assembly, the cathode-side flow controller configured to cause a pressure differential such that an upstream side of the cathode-side flow controller is at a greater pressure than a downstream side of the cathode-side flow controller; and
an input flow controller arranged between the water control assembly and the stack inlet, the input flow controller configured to cause a pressure differential such that an upstream side of the input flow controller is greater than a downstream side of the input flow controller.

9. The oxygen generation system of claim 1, wherein each of the anode-side phase separator and the cathode-side phase separator are membrane phase separators.

10. The oxygen generation system of claim 1, further comprising a water replenishment system configured to supply water into the mixture of liquid water and gaseous oxygen that is output from the anode.

11. The oxygen generation system of claim 10, wherein the water replenishment system comprises a forward pressure regulator arranged between a water source and a resupply junction, wherein the resupply junction is located between the anode and the anode-side phase separator.

12. The oxygen generation system of claim 1, wherein the water control assembly comprises a pump configured to control a pressure of the water within the system.

13. The oxygen generation system of claim 1, further comprising a set of pressure sensors arranged within the system and configured to monitor a fluid pressure at respective locations of the pressure sensors, wherein the pressure sensors are arranged in communication with the controller.

14. The oxygen generation system of claim 1, wherein a sweep flow of air is supplied into oxygen portions of the anode-side phase separator to flush residual free hydrogen from the anode-side phase separator.

15. The oxygen generation system of claim 1, wherein the oxygen outlet is fluidly connected to a space to be occupied by humans.

16. The oxygen generation system of claim 1, wherein the oxygen outlet is fluidly connected to an oxygen storage system.

17. A method of generating oxygen in a low-gravity environment, the method comprising:
supplying water to a stack inlet of a cell stack comprising an anode and a cathode and performing electrolysis on the water, wherein the stack inlet is fluidly coupled to the anode;
outputting a flow of liquid water and gaseous oxygen from the anode;
separating the gaseous oxygen from the liquid water in an anode-side phase separator;
directing the gaseous oxygen to an oxygen outlet;
outputting a flow of liquid water and gaseous hydrogen from the cathode;
separating the gaseous hydrogen from the liquid water in a cathode-side phase separator;
directing the gaseous hydrogen to a hydrogen outlet;
directing the liquid water output from the anode-side phase separator and the cathode-side phase separator back to the stack inlet;
monitoring a concentration of hydrogen within a ducting system, wherein the cell stack and the cathode-side phase separator are housed within the ducting system; and
in response to a detection of a hydrogen concentration at or above a threshold concentration within the ducting system, stopping the electrolysis in the cell stack.

18. The method of claim 17, further comprising:
directing the liquid water output from the anode-side phase separator and the cathode-side phase separator to a water control assembly;
recombining the water from the anode-side phase separator and the cathode-side phase separator in the water control assembly; and
directing the recombined water to the stack inlet.

19. The method of claim 17, further comprising adding water to the system along a fluid path between an outlet of the anode and an inlet of the anode-side phase separator, wherein the water is added from a water replenishment system.

20. The method of claim 19, wherein the water replenishment system comprises a water source and a forward pressure regulator, the method further comprising:
adding water to the system from the water source to maintain a predetermined water volume or water pressure within the system.
